(19) United States
(12) Patent Application Publication
(10) Pub. No.: US 2022/0003360 A1
(43) Pub. Date: Jan. 6, 2022

(54) Aljrbi Tank

(71) Applicant: Abdulkariem Mukhtar Aljrbi, Montreal (CA)

(72) Inventor: Abdulkariem Mukhtar Aljrbi, Montreal (CA)

(21) Appl. No.: 16/919,123

(22) Filed: Jul. 2, 2020

(51) Int. Cl. F17C 1/02

(52) U.S. Cl. CPC F17C 1/02; F17C 2203/012; F17C 2201/0185; F17C 2203/0658; F17C 2203/0604

(57) ABSTRACT

This disclosure relates generally to a storage tank for storing a fluid, such as water, having a wall defined by a plurality of panels which are retained by opposed side edges between adjacent support members. The support members have a base portion and a support portion and are free-standing on the base portion on an earthen floor allowing the tank to be constructed at sites without concrete foundations such as a concrete pad or ring. The tank also has a liner that lines the interior surfaces of the wall and the floor. The main embodiment of the invention is based on a design where the storage water tank is divided by a rubber membrane from the middle of the tank. This will divide the single tank to act as two separate tanks with the ability to operate independently in terms of storage, water/liquid intake and water/liquid output through an outlet. The concept is to provide each half of the tank as a full tank from input and output separated by a rubber membrane.

### FIELD OF THE INVENTION

The present invention relates to storage tanks and more particularly to tanks for storing volumes of different types of liquids.

The invention relates to tanks. In particular, the invention relates, but is not limited, to free-standing fluid, preferably water, storage tanks that are erected at the site without a concrete foundation. The current invention is a tank with two partitions with their inlet and outlet system. The partition is intended to be made from high pressure and temperature bearing material for storing two different types of fluids and have optimum dual-purpose usage at the same.

The present invention holds its novelty as currently limited or no similar devices are available for storage of fluids, liquids and especially for volatile liquids with partition. In the same context, the current invention is based on the usage of the tank with a partition so that two different types of fluids can be stored and used under high pressure, high temperature and volatile atmosphere when required.

### BACKGROUND

Reference to background art herein is not to be construed as an admission that such art constitutes common general knowledge currently across the globe.

Tanks of various shapes and sizes are known for storing fluids, in particular liquids, such as water. Such tanks vary in size tremendously from, for example, a personal water storage tank for drinking or irrigation purposes to industrial or commercial storage tanks. Small tanks are relatively easy to assemble and can often be moulded as a single piece (e.g. 1-5 KL water storage tanks). However, as tank sizes increase it becomes increasingly more difficult to construct a sealed tank for storing fluid.

One of the issues with constructing large tanks is in transporting and building the tank, particularly for remote locations. For example, in mining, oil, and gas applications, water is a common by-product which may be processed and/or stored in tanks, or reservoirs, or the like. Furthermore, primary extraction fluids, such as oil or condensate, are also often stored in holding tanks. The storage of these liquids in the tanks may be long term or temporary. In any event, often the well or mine site is in a remote location with limited infrastructure and building a tank requires significant preparation.

Typically a site for a tank requires earth working, grading, and a concrete pad or footing. In one tank design, an annular concrete footing is provided which tracks the perimeter of the tank. The tank walls then extend off the pad or footing. Considerable time and expense are taken to prepare the site for tank construction. Furthermore, often tanks are or have to be, decommissioned at the end of their use or life. This includes digging up and removing the concrete pad or footing which is again time-consuming and costly. There may also be adverse environmental impacts from utilising, and subsequently disposing of the concrete pad or footing.

Large tanks also often suffer from hoop stress and, when empty, wind loading. To avoid these variables tanks may be designed of a limited size. This is undesirable if a larger tank is required, usually necessitating multiple tanks where one larger tank may have been sufficient.

Furthermore, the walls of the tank may need to be reinforced with an external structure. For example, the walls of the tank may be reinforced with a frame. Such a frame typically has support members which extend radially outwards from the tank walls. In one tank design, the support members are steel ‘A’-frame members. Disadvantageously, such a supporting framework requires additional space around the tank walls. As the support members need to be provided with suitable support, the concrete pad or footing also needs to be large enough to extend to at least the outer edge of the framework, further increasing costs and environmental impact of the tank.

The current invention is a reusable, dual purposed and would have the approval of market-based standards. The invention holds its novelty when compared to the current market for utility and features fulfilling the requirement of having a fluid container capable of varied volumes, which may include a mechanism to improve the storage of multiple fluid containers.

Concerning previous inventions or utility of such products associated with storage and travel bottles, which are reusable, dual purposed and abide by travelling regulations holds its uniqueness and usability in its domain. The previous inventions did not have or had limited utility. With all previous embodiments in the field did not provide such facilitation and hence the idea has its novelty.

### SUMMARY

According to a first aspect of the invention, there is provided with a storage tank for storing a fluid, the storage tank comprising a wall defined by a plurality of panels and a plurality of support members, wherein each of the support members has a base portion and a support portion, and each panel is retained, by opposed side edges, between respective support portions. The tank preferably further comprises a liner. The liner is preferably located on at least an inner side of the wall. The liner preferably lines an inner surface of the tank defined by the inner surface of the wall and a floor. The floor preferably includes a surface upon which the support members are placed. The surface may be earthen, preferably graded. Preferably the tank, and in particular the support members, do not require, or even include, a concrete surface or concrete foundations for support.

The invented water tank are preferably free-standing on the base portion on a surface. Necessary support portions would be present to support the tank structure and any number of partitions. In the beginning, two partitions are intended for the water tank. The support portion is preferably welded or moulded to the base portion according to the material of the tank. The partition of the tank will be done by specific material which can bear high pressure and temperature.

In another embodiment the invention provides the provision of the strength of walls and boundaries is based on the construction of alternating support members and panels, and is preferably free-standing and supported vertically by the base portion of the support members. The support portion is preferably substantially perpendicular to the base portion. The base portion is preferably planar and/or rectangular.

The stressing support member preferably has at least one aperture that is vertically offset from a corresponding aperture on the standard support members. Preferably the vertically offset aperture is higher than the corresponding aperture on the standard support members. Preferably the stressing support member has a vertically offset aperture corresponding to each of the apertures on the standard support member. The stressing support member may also have one or more apertures corresponding directly to the apertures on the standard support member (i.e. not offset). One or more of the apertures of the stressing support member may be reinforced.

The tank may further comprise a leak detection system. The leak detection system may comprise a leak detection liner. The leak detection liner is preferably adjacent and external to, a primary liner (described previously). The leak detection liner preferably has an outlet in fluid communication with a conduit. The leak detection liner and/or outlet preferably comprise a sump. The conduit preferably extends from the fluid detection liner outlet to a leak detection location outside of the tank wall.

The main feature of the water tank design is to divide the tank by a rubber membrane from the middle of the tank. Each half is treated as a full tank from input and output. The movement of rubber membrane into the empty half direction, which makes the tank, uses all its capacity. Also, the full tank can be used to store two kinds of fluid materials, even being volatile or two opposite liquid materials within one tank.

This Summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims. In light of the disadvantages of the prior art, the following summary is provided to facilitate an understanding of some of the innovative features unique to the present invention and is not intended to be a full description.

### BRIEF DESCRIPTION OF DRAWING

The invention will be described concerning the following drawings, in which like reference numerals represent like features throughout the figures, and in which:

FIG. 1 is a perspective view of the device with side view. The figure shows the Outlet system of the tank and the partition with requisite material is also visible. The figure shows a cross-sectional view of the tank from the side perspective.

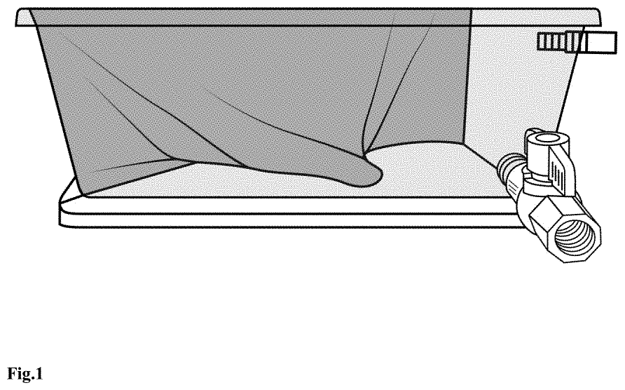

FIG. 2 is the perspective side view of the tank showing the inlet and outlet system with the partition. The figure shows the horizontal division of the tank through partition material.

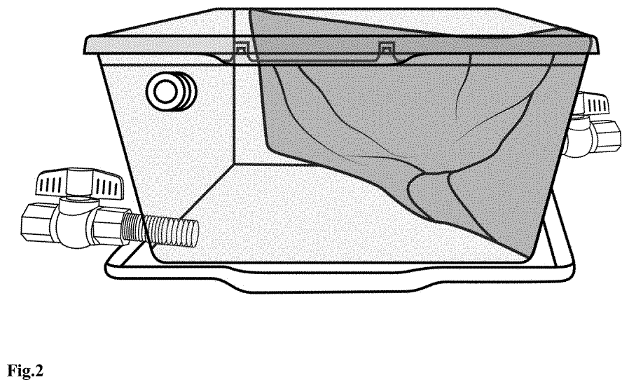

FIG. 3 is a perspective view of the device with an aerial view of the tank showing the overall tank embodiments assembled in the tank. The picture shows the partition pattern, two separate partitions within the tank and the inlet & outlet system.

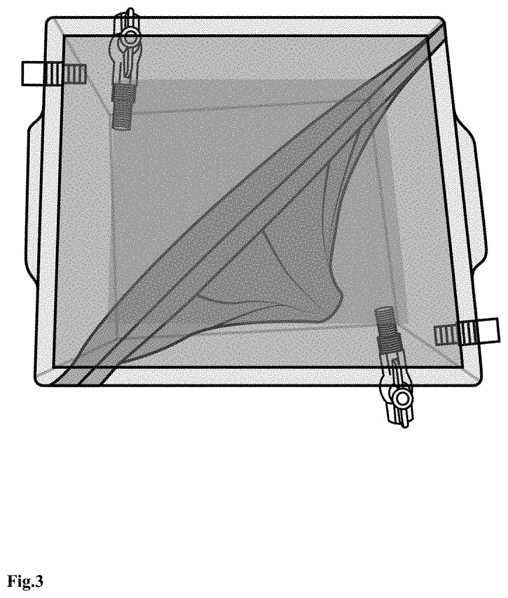

FIG. 4 is the perspective top view of the tank. It shows the standing view of the tank with an inlet/outlet system and also shows the cover of the tank. The view gives the complete perspective of the invention in one view.

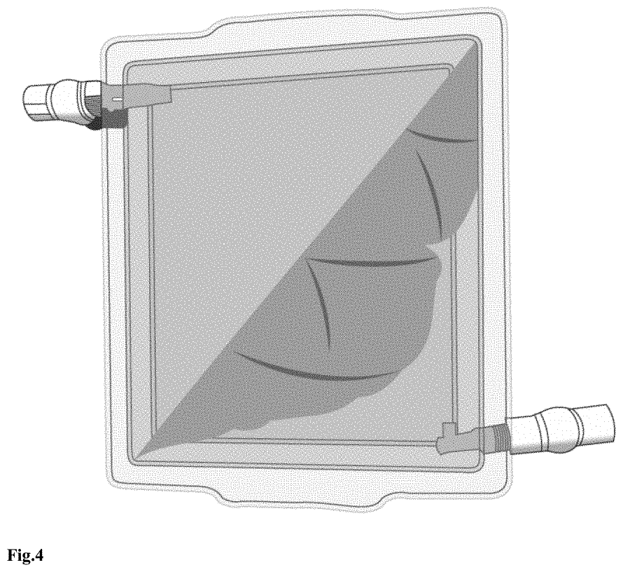

FIG. 5 is a perspective view of the device with side view. The figure shows the Inlet system of the tank and the partition with requisite material is also visible. The figure shows a cross-sectional view of the tank from the side perspective opposite of the outlet system.

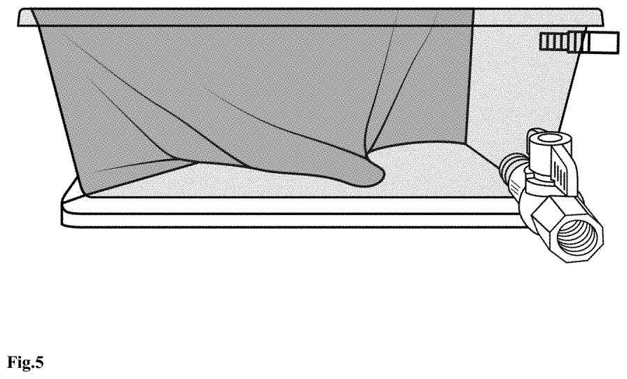

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current storage tank is designed to withstand internal pressures which will minimize the vapor losses. The choice of these design pressures is based upon the type of liquid to be stored, the vapor pressure of the liquid at the anticipated maximum and minimum surface temperatures, and the maximum and minimum temperatures of the vapor space above the liquid. The design pressures may vary from a few ounces per square inch to as much as 30 or 40 pounds per square inch. The volume of such tanks may vary from five or ten thousand barrels to one or more hundred thousand barrels.

It is the primary object of the present invention to construct a storage tank for all types of liquids including volatile liquids that will satisfy all loading conditions. It is another object of the invention to provide a storage vessel having a substantially flat bottom and to provide weighted means at the juncture of the side walls with the bottom to restrain upward movement of the lower portions of the side walls as the liquid within the vessel is withdrawn.

It is a further object of the invention to provide a vessel having curved sidewalls and means to restrain inward movement of the side walls upon decrease of the hydrostatic pressures against said sidewalls, thus preventing excessive compressive stresses within the wall plates and possible buckling thereof. The tank is proposed to be constructed from the material normally used for constructing storage tanks are polyethene, thermoplastic, or glass-reinforced plastic (fibreglass). Selection of the material will be custom based and will depend on the utility of the tank. The material shall be used according to the requirement of usage and will be designed to gauge high temperature, pressure and other related environmental factors.

It is still another object of the invention to provide a roof structure designed not only fully to support the roof loading but also to counteract compressive stresses in the sidewall plates. Another object of the invention is to utilize the advantages of the spheroid type of storage vessel and so to reinforce the walls of the vessel that liquids may be stored safely and economically therein.

The main embodiment of the invention is based on a design where the storage water tank is divided by a rubber membrane from the middle of the tank. This will divide the single tank to act as two separate tanks with the ability to operate independently in terms of storage, water/liquid intake and water/liquid output through an outlet. The concept is to provide each half of the tank as a full tank from input and output separated by a rubber membrane.

The rubber membrane used for partition would have the ability of flexible movement. In case the tank is used as a single unit, the movement of rubber membrane into the empty half direction will transform the tank into a single unit, hence, using all its capacity.

In the same context, the invention has an embodiment where the full tank can be used to store two kinds of fluid materials. Just for elaboration purpose, a single tank can be used to store fresh water and sewage water at the same time. Further, the amount of freshwater utilized or used will be overtaken through the principle of injection by sewerage water stored in the second half. This will be enabled by the flexible movement of the rubber membrane separating the tank into two partitions.

The utility of such tanks is perfect in an Airline or Starship. The tank is designed in a manner where the efficiency of the entire tank is used by freshwater when going up to space or in the initial half of the flight and the same efficiency of the entire tank is reused by sewage water when returning to the ground when the all the waste is to be disposed of.

In the current invention the most important factor is based on the material of the rubber membrane used for the partition of the tank. Ideally, the rubber membrane would be of Perfluoroelastomers which are fluoroelastomers with higher fluorine content. Perfluoroelastomers contain an even higher amount of fluorine. The material has improved resistance to high temperatures and chemicals and even withstands environments where Oxygen-Plasma are present for many hours. The material can be available in certain grades that have a maximum continuous service temperature of 327° C. (621° F.). They are commonly used to make O-rings that are used in applications that involve contact with hydrocarbons or highly corrosive fluids, or when a wide range of temperatures is encountered.

The design of the tank is planned for future use in planes, starships and other high-tech and military industry. The separating material is proposed to be of highly specialized material and Perfluoroelastomers are proposed to be used as the raw material for the production of O-rings and rubber membrane. Due to high temperatures, high pressures and highly volatile environment, there is no choice other than these materials to seal valves used in those facilities.

The second choice for the rubber membrane and partition material is suggested as fluoroelastomers. Due to lower fluorine content, they are more susceptible to environmental attacks. They, however, are significantly cheaper than perfluoro elastomers and can be used in environments where the temperature is lower. These best suit for applications, industries and places where the temperature is around 200° C.

The main feature of the water tank design is to divide the tank by a rubber membrane from the middle of the tank as discussed above in the summary as well. Each half is treated as a full tank from input and output. The movement of rubber membrane into the empty half direction, which makes the tank, uses all its capacity. Also, the full tank can be used to store two kinds of fluid materials, even being volatile or two opposite liquid materials within one tank.

One of the best utility of the newly designed water tank is in the maritime industry especially oil tanker. Once the oil is transported for import or export to countries the oil tankers travel a long distance. On return, the vessels and oil tankers are filled with water in the tanks. The exporting company/country needs to clean the tank to fill water, which is a very costly process. The current invention would save huge cost for companies as the tank does not require cleaning the tank each time oil is emptied and supplied off. The tank is designed in a manner where the rubber barrier/partition, which is made of high pressure and temperature resistance material divides the tank in two equal part with the same capacity and weight load. On the way to export half tank allocated for oil, storage can be filled with oil and on the way back the other half of the tank can be filled with water. This will allow companies to save efforts and revenues to clean oil tank each time.

The design of the tank and dual utility is one of the basic features with the main part is the pressure and temperature bearing barrier/partition of rubber. The concept is applicable for use of aircraft, space crafts and other maritime industry. The concept, design and product are not limited for use in such industries but also holds its validity for usage in other industries including housing and leisure industry.

To the extent that the term “includes” or “including” is used in the specification or the claims, it is intended to be inclusive like the term “comprising” as that term is interpreted when employed as a transitional word in a claim. Thus, use of the term “or” herein is the inclusive, and not the exclusive use. Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

1. A storage tank for storing a fluid, the storage tank comprising:
A wall defined by a plurality of panels and a plurality of support members, wherein each of the support members has a base portion extending perpendicularly to the wall and a support portion that receives a reinforcement assembly and each panel is retained by opposed side edges between respective support portions.

2. A storage tank according to claim 1, further comprising a liner located on an inner side of the wall.

3. A storage tank according to claim 1, wherein the liner lines an inner surface of the tank defined by an inner surface of the wall and a floor of the tank.

4. A storage tank according to claim 1, wherein the floor of the tank is the surface upon which the support members are placed.

5. A storage tank according to claim 1, wherein the floor is earthen and made from a material other than concrete but ensuring the maximum durability.

6. A storage tank according to claim 1, wherein the base portion is divided through a rubber membrane.

7. According to claim 1, the division by rubber membrane will ensure that the tank can store and operate two different types of materials/fluids/liquids at the same time.

8. According to claim 1, each of the support, members are planar and substantially perpendicular to a longitudinal axis of the respective support portion.

9. According to claim 2, wherein each part of the tank will have its independent inlet and outlet to operate independently.

10. According to claim 2, the storage tank separator consisting of rubber membrane, which would be of a material resistant to high temperature, pressure and wear-tear.

11. According to claim 2, the rubber membrane would have the property of elasticity and would adjust the tank capacity according to fluid/liquid material contained within any side.

12. A storage tank according to claim 2, wherein at least one of the support members is a stressing support member, the stressing support member including a flange and a tab connected to the flange.
